(19) United States
(12) Patent Application Publication
(10) Pub. No.: US 2007/0200067 A1
(43) Pub. Date: Aug. 30, 2007

(54) Optical gas-detecting device

(75) Inventor: Takahiko Yoshida, Okazaki-city (JP)

Correspondence Address: POSZ LAW GROUP, PLC, 12040 SOUTH LAKES DRIVE, SUITE 101, RESTON, VA, 20191, US

(73) Assignee: DENSO CORPORATION, Kariya-city (JP)

(21) Appl. No.: 11/640,873

(22) Filed: Dec. 19, 2006

(30) Foreign Application Priority Data
Feb. 27, 2006 (JP) 2006-51177

(51) Int. Cl. G01J 1/42

(52) U.S. Cl. 250/373

(57) ABSTRACT

An optical gas-detecting device for measuring a concentration of a gas to be measured includes a light source for radiating ultraviolet rays, a detecting element for detecting the radiated ultraviolet rays, and a light path, through which the radiated ultraviolet rays pass from the light source to the detecting element. The gas to be measured is introduced into the light path and absorbs a part of the radiated ultraviolet rays with an absorption band. The detecting element detects an absorption rate of the gas so as to measure the concentration of the gas.

### CROSS REFERENCE TO RELATED APPLICATION

This application is based on Japanese Patent Application No. 2006-051177 filed on Feb. 27, 2006, the disclosure of which is incorporated herein by reference in its entirety.

### BACKGROUND OF THE INVENTION

1. Field of the Invention

The present invention relates to an optical gas-detecting device.

2. Description of Related Art

US 2005/0161605 A1 (corresponding to JP-A-2005-208009) discloses a non-dispersion infrared rays (NDIR) gas-detecting device as an optical gas-detecting device. The NDIR gas-detecting device includes an infrared light source for radiating infrared rays, and an infrared sensor for detecting the radiated infrared rays.

The NDIR gas-detecting device can detect a polyatomic molecule, e.g., CO₂, NH₃ The polyatomic molecule absorbs infrared rays with a predetermined wavelength band, because atoms included in the polyatomic molecule oscillate with its natural frequency in an infrared band. That is, an absorption band of the polyatomic molecule is in the infrared band.

In contrast, the NDIR gas-detecting device cannot detect a monoatomic molecule, e.g., O₂, H₂, because an absorption band of the monoatomic molecule is in an ultraviolet band.

### SUMMARY OF THE INVENTION

In view of the foregoing and other problems, it is an object of the present invention to provide an optical gas-detecting device for detecting gas having its absorption band in an ultraviolet band. It is a further object of the present invention to provide an optical gas-detecting device, which can detect a monoatomic molecule.

According to an example of the present invention, an optical gas-detecting device for measuring a concentration of a gas to be measured includes a light source for radiating ultraviolet rays, a detecting element for detecting the radiated ultraviolet rays, and a light path, through which the radiated ultraviolet rays pass from the light source to the detecting element. The gas to be measured is introduced into the light path and absorbs a part of the radiated ultraviolet rays with an absorption band. The detecting element detects an absorption rate of the gas so as to measure the concentration of the gas.

Accordingly, the optical gas-detecting device can detect the gas having its absorption band in the ultraviolet band. For example, the gas is a monoatomic molecule such as oxygen or hydrogen. Therefore, the optical gas-detecting device can detect the monoatomic molecule.

### BRIEF DESCRIPTION OF THE DRAWINGS

The above and other objects, features and advantages of the present invention will become more apparent from the following detailed description made with reference to the accompanying drawings. In the drawings:

FIG. 1 is a schematic pattern diagram showing an example of an optical gas-detecting device according to an embodiment of the present invention;

FIG. 2 is a schematic side view showing an arrangement of a wavelength-selecting filter and a detecting element;

FIG. 3A is a cross-sectional view showing an example of a housing including a reflection layer, and FIG. 3B is a cross-sectional view showing another example of a housing including the reflection layer and a protection layer;

FIG. 4 is a schematic pattern diagram showing another example of an optical gas-detecting device of the embodiment; and

FIG. 5 is a schematic pattern diagram showing another example of an optical gas-detecting device.

### DETAILED DESCRIPTION OF PREFERRED EMBODIMENT

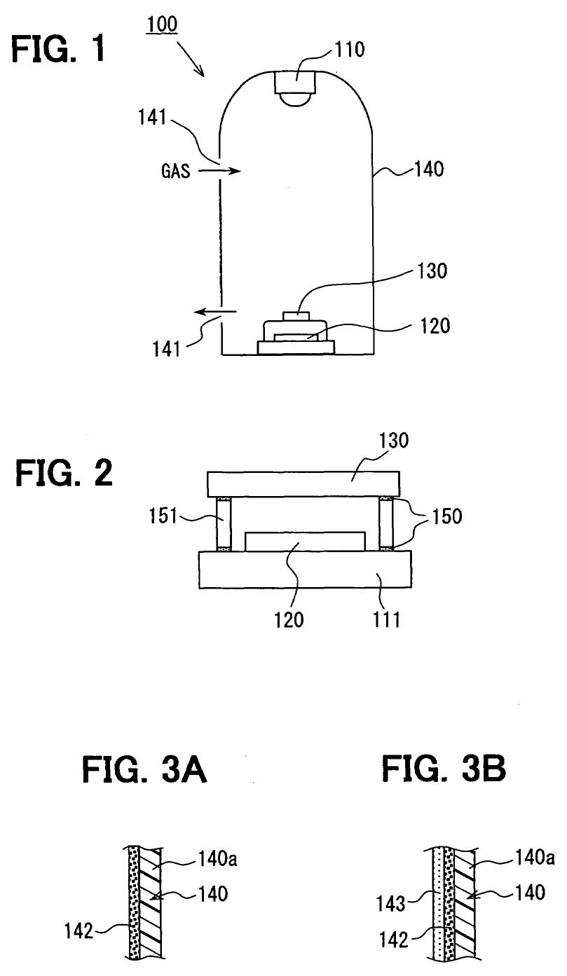

An optical gas-detecting device 100 detects gas having its absorption band in an ultraviolet band, in which the gas absorbs ultraviolet rays with a predetermined wavelength. As shown in FIG. 1, the device 100 includes a light source 110 for radiating ultraviolet rays, a detecting element 120 for detecting the radiated ultraviolet rays, a wavelength-selecting filter 130 and a housing 140. The filter 130 is positioned in a light path of ultraviolet rays radiated from the light source 110 to the detecting element 120. The housing 140 accommodates the light source 110, the detecting element 120 and the filter 130.

Ultraviolet rays radiated from the light source 110 have a wavelength band including the absorption band of the gas. In order to correspond to the absorption band of the gas, the wavelength band has a broad range, e.g., 200-400 nm, which corresponds to the ultraviolet rays and near-ultraviolet rays. Specifically, an excimer lamp or a mercury lamp is used as the light source 110.

A photoconduction element or a photovoltaic element is used as the detecting element 120. Specifically, a photodiode made of a compound semiconductor such as GaAs is used as the detecting element 120. The photodiode outputs an electrical signal corresponding to an intensity of ultraviolet rays passing through the filter 130.

When the light source 110 radiates ultraviolet rays with the broad wavelength band, for example, the filter 130 selectively transmits ultraviolet rays with a predetermined wavelength band corresponding to the absorption band of the gas. Then, the transmitted ultraviolet rays are received by the detecting element 120. Specifically, a Fabry-Perot filter is used as the filter 130. By using the Fabry-Perot filter, the predetermined wavelength band can be freely controlled. In the Fabry-Perot filter, two transmission filters made of Mo, Si or Ge are disposed to face each other through air space, and a dimension of the air space can be freely changed. Therefore, the Fabry-Perot filter is a variable filter, in which multipath reflections are generated between the air space. For example, the Fabry-Perot filter is formed by using a micro electro mechanical system (MEMS) technology, as shown in JP-A-2005-215323, which is incorporated herein by reference. A diffraction grating may be used as the variable filter, other than the Fabry-Perot filter.

As shown in FIG. 2, the filter 130 is arranged above the detecting element 120 with a small space, and fixed to a supporting portion 151 through an adhesive 150. Thus, a size of the device 100 can be made to be smaller. The supporting portion 151 is disposed on a substrate 111 beneath the detecting element 120 in order to make the small space between the substrate 111 and the filter 130. The filter 130 may be directly arranged on a light-receiving face of the detecting element 120 without the supporting portion 151, and fixed to the detecting element 120 through the adhesive 150. In this case, the size of the device 100 can be made to be much smaller.

If the adhesive 150 is made of an organic material, e.g., polymeric material, reliability for a long-range connection is difficult to be secured, because the organic material deteriorates due to ultraviolet rays. In contrast, the adhesive 150 in this embodiment is made of an inorganic material, e.g., silicon, which has a better endurance performance than the organic material. Therefore, the reliability for the long-range connection can be secured.

The housing 140 is constructed with a housing member 140a made of synthetic resin or metal, e.g., Al, and accommodates the light source 110, the detecting element 120 and the filter 130. A light path of the ultraviolet rays radiated from the light source 110 to the detecting element 120 is limited by the housing 140. That is, the light path is included in an inner space of the housing 140. The housing 140 is formed of a tube portion. The light source 110 is disposed so as to cover one aperture end of the tube portion, and the detecting element 120 is disposed so as to cover the other aperture end of the tube portion. Therefore, the ultraviolet rays radiated from the light source 110 are directly received by the detecting element 120 through the filter 130, or the ultraviolet rays radiated from the light source 110 are received by the detecting element 120 through the filter 130 after reflected by the housing 140. Thereby, sensitivity of the detecting element 120 can be improved, because light-receiving efficiency can be improved. In addition, as shown in FIG. 1, the housing 140 includes window portions 141, through which gas in the inner space of the housing 140 communicates with gas outside of the housing 140.

As shown in FIG. 3A, in order to more improve the sensitivity, a reflection layer 142 for reflecting ultraviolet rays is arranged on an inner face of the housing member 140a in the housing 140. Thereby, the sensitivity can be improved, because reflecting efficiency on the inner face of the housing 140 can be improved. Further, deterioration of the housing 140 due to ultraviolet rays can be reduced, and the reduction is effective especially when the housing 140 is made of synthetic resin.

The reflection layer 142 is formed with a white material, for example, because efficiency for reflecting ultraviolet rays by the white material is better than that by other colored material. Especially when the white material is made of an inorganic material, deterioration of the reflection layer 142 can be reduced, compared with a case in which the white material is made of an organic material. For example, a white pigment, e.g., ZnO, TiO₂ or lithopone, can be used as the white inorganic material.

Alternatively, the reflection layer 142 may be formed with a metal material, for example, other than the white material, because efficiency for reflecting ultraviolet rays on the metal surface is better than that on a resin or ceramic surface. For example, Ag, Al, Au, Cr, Cu, Ni, Ti or Pt having a high performance for reflecting ultraviolet rays can be used as the metal material. A film made of the metal material is formed on the inner face of the housing member 140a as the reflection layer 142 by sputtering, chemical vapor deposition (CVD), or plating.

If the materials forming the reflection layer 142 have endurance performance against ultraviolet rays, the reflection layer 142 can be exposed to the gas. Alternatively, as shown in FIG. 3B, a protection layer 143 may be formed on the reflection layer 142 in the housing 140. The protection layer 143 is made of an inorganic material, and has a higher performance for transmitting ultraviolet rays than the reflection layer 142. Thereby, deterioration of the reflection layer 142 due to ultraviolet rays can be reduced, and the reflection layer 142 can be restricted from being separated from the housing 140. That is, reflection efficiency of the reflection layer 142 can be maintained, because the reflection layer 142 can be kept on the inner face of the housing 140. Further, lowering in reflection efficiency due to the protection layer 143 can be reduced, because the protection layer 143 has the high performance for transmitting ultraviolet rays. For example, MgF₂, SiO₂, SiN or SiON having the high performance for transmitting ultraviolet rays can be used for forming the protection layer 143. Especially, a silica glass including fluorine may be used for forming the protection layer 143.

If a surface for reflecting ultraviolet rays has a larger surface roughness, efficiency for reflecting ultraviolet rays is decreased. Especially, when the surface roughness exceeds a threefold detection wavelength, the efficiency for reflecting ultraviolet rays is rapidly decreased. The detection wavelength represents a wavelength of ultraviolet rays to be detected, and corresponds to a wavelength in the absorption band of the gas. Therefore, the surface roughness of the inner face of the housing 140 including the reflection layer 142 is controlled to be equal to or less than the threefold detection wavelength, e.g., 1.2 μm. Thus, efficiency for reflecting ultraviolet rays can be enhanced. That is, deterioration of the housing 140 due to ultraviolet rays can be reduced, and sensitivity of the detecting element 120 can be improved. In addition, when the surface roughness of the inner face of the housing 140 is controlled to be equal to or less than the detection wavelength (0.2 μm), the efficiency for reflecting ultraviolet rays can be much improved.

As described above, the optical gas-detecting device 100 includes the variable Fabry-Perot filter as the filter 130. Therefore, multiple gases with different absorption bands can be measured by using only one set of the filter 130 and the detecting element 120, as shown in FIG. 1, because the wavelength of the ultraviolet rays transmitted through the Fabry-Perot filter can be adjustable. Further, the device 100 has a reference function for detecting ultraviolet rays with a wavelength band different from the absorption band of the gas. A temperature of the gas influences an amount (intensity) of ultraviolet rays absorbed by the gas, and a deterioration of the light source 110 also influences the amount (intensity) of the ultraviolet rays. However, these influences can be reduced by the reference function. Moreover, a size of the device 100 can be made to be smaller, because the device 100 has the reference function without an addition of parts.

According to the optical gas-detecting device 100, gas having its absorption band in an ultraviolet band can be measured. For example, a monoatomic molecule such as a homonuclear diatomic molecule, e.g., oxygen or hydrogen, can be detected, because the monoatomic molecule has its natural oscillation frequency in the ultraviolet band. The natural oscillation frequency represents the absorption band of the monoatomic molecule, in which the monoatomic molecule oscillates and absorbs the ultraviolet rays. In this embodiment, the device 100 detects oxygen. Because oxygen has its absorption band of 200-240 nm, a wavelength of about 300 nm is used as a reference wavelength. Oxygen concentration is calculated by comparing an electrical signal output when ultraviolet rays having a wavelength corresponding to oxygen are detected, and an electrical signal output when ultraviolet rays having the reference wavelength are detected. That is, the detecting element 120 detects an absorption rate of a gas so as to measure a concentration of the gas. In addition, oxygen and hydrogen may be detected at the same time.

In this embodiment, the filter 130 is arranged above the detecting element 120. However, the position of the filter 130 is not limited to this. Alternatively, the filter 130 may be disposed in any position in the light path. For example, the filter 130 may be arranged on the light source 110.

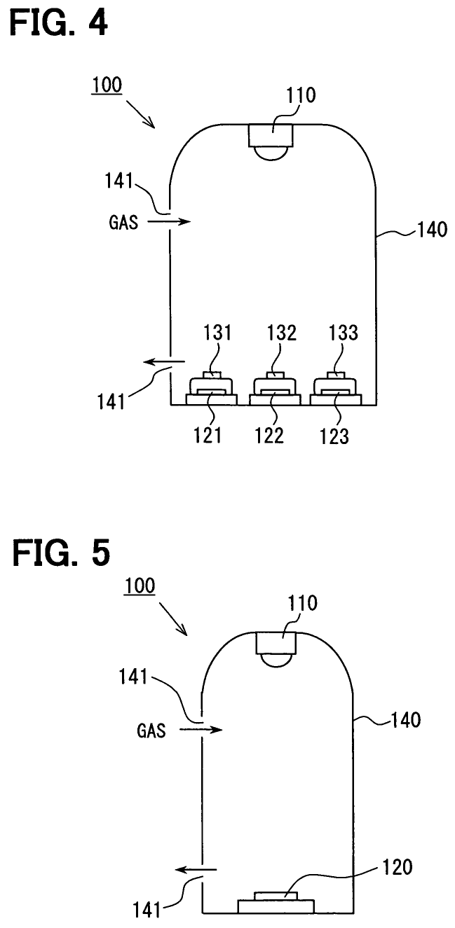

In this embodiment, the movable Fabry-Perot filter is used as the filter 130. Alternatively, a multi-layered filter may be used as the filter 130. The multi-layered filter is formed by alternately layering metal films having different refractive indexes. Thereby, ultraviolet rays with a predetermined wavelength can be selectively transmitted through the filter 130. Therefore, as shown in FIG. 4, in order to detect multiple gases with different absorption bands, wavelength-selecting filters 131, 132 and detecting elements 121, 122 may be included in the device 100, for example. Each of the filters 131, 132 and each of the detecting elements 121, 122 correspond to each of the multiple gases. Further, in a case in which a reference is required, a reference filter 133 and a reference detecting element 123 may be included in the device 100, for example, as shown in FIG. 4.

In this embodiment, in order to correspond to the absorption band of the gas, the light source 110, e.g., an excimer lamp or a mercury lamp, radiates ultraviolet rays with the broad band, e.g., 200-400 nm. However, the light source 110 is not limited to this example. Alternatively, a light-emitting diode (LED) made of III-group nitride semiconductor or a laser, e.g., ArF laser, F₂ laser or laser diode (LD), may be used as the light source 110. Because the LED and the laser have a narrow wavelength band and a high directivity, sensitivity of the detecting element 120 can be improved. Further, as shown in FIG. 5, the filter 130 may be eliminated. Thereby, a size of the device 100 can be made smaller. Furthermore, because the LED and the LD are small light-emitting elements, the size of the device 100 can be made to be much smaller. Furthermore, in order to detect multiple gases having different absorption bands, the light source 110 may be used for radiating ultraviolet rays with the corresponding absorption bands, and the detecting element 120 may be used for detecting the ultraviolet rays. Furthermore, in a case in which a reference is required, a reference light source and a reference detecting element may be included in the device 100. The reference filter transmits ultraviolet rays with a wavelength band, which is different from the absorption band of the gas to be detected, and the reference detecting element detects the ultraviolet rays transmitted through the reference filter.

In this embodiment, the light source 110 is disposed so as to cover one aperture end of the tube portion, and the detecting element 120 is disposed so as to cover the other aperture end of the tube portion. Alternatively, the light source 110 and the detecting element 120 may be disposed on the same end of the tube portion. In this case, ultraviolet rays radiated from the light source 110 are reflected by a mirror, and the reflected ultraviolet rays are transmitted to the detecting element 120.

In this embodiment, the light source 110, the detecting element 120 and the filter 130 are disposed in the housing 140. However, the housing 140 may not be included in the device 100, when the detecting element 120 detects the radiated ultraviolet rays from the light source 110 and when the detecting element 120 measures a gas concentration by detecting an absorption rate of the gas introduced into the light path from the light source 110 to the detecting element 120.

Such changes and modifications are to be understood as being within the scope of the present invention as defined by the appended claims.

What is claimed is:

1. An optical gas-detecting device for measuring a concentration of a gas to be measured, the device comprising:
a light source for radiating ultraviolet rays;
a detecting element for detecting the radiated ultraviolet rays; and
a light path, through which the radiated ultraviolet rays pass from the light source to the detecting element, wherein
the gas to be measured is introduced into the light path and absorbs a part of the radiated ultraviolet rays with an absorption band, and
the detecting element detects an absorption rate of the gas so as to measure the concentration of the gas.

2. The device according to claim 1, wherein:
the gas is a monoatomic molecule.

3. The device according to claim 2, wherein:
the gas is at least one of oxygen and hydrogen.

4. The device according to claim 1, further comprising:
a wavelength-selecting filter, which is disposed in the light path, for selectively transmitting ultraviolet rays with a predetermined wavelength band, wherein
the radiated ultraviolet rays include the predetermined wavelength band.

5. The device according to claim 4, wherein:
the filter is arranged on the detecting element, and fixed to the detecting element through an adhesive.

6. The device according to claim 5, wherein:
the adhesive is made of an inorganic material.

7. The device according to claim 4, wherein:
the filter is made of a multi-layered film, in which multiple metal films are layered.

8. The device according to claim 7, wherein:
the gas is one of a plurality of gases with different absorption bands; and
a set of the filter and the detecting element is one of a plurality of sets of filters and detecting elements, each of the sets corresponds to each of the gases.

9. The device according to claim 7, further comprising:
a reference filter for transmitting ultraviolet rays with a wavelength band, which is different from the absorption band of the gas to be detected; and
a reference detecting element for detecting the ultraviolet rays transmitted through the reference filter.

10. The device according to claim 4, wherein:
the filter is a variable filter, in which the predetermined wavelength band to be transmitted is controllable.

11. The device according to claim 1, further comprising:
a housing having therein the light path, wherein
the gas is introduced into the housing.

12. The device according to claim 11, further comprising:
a reflection layer on an inner face of the housing, wherein
the reflection layer reflects the radiated ultraviolet rays.

13. The device according to claim 12, wherein:
the reflection layer is made of a white material.

14. The device according to claim 12, wherein:
the reflection layer is made of a metal material.

15. The device according to claim 12, further comprising:
a protection layer on the reflection layer, wherein
the protection layer is made of an inorganic material, and has a higher performance for transmitting the radiated ultraviolet rays than the reflection layer.

16. The device according to claim 11, wherein:
the housing has an inner face with a surface roughness, which is controlled to be equal to or less than three times of a detection wavelength of ultraviolet rays detected by the detecting element.

17. The device according to claim 16, wherein:
the surface roughness of the inner face of the housing is equal to or less than the detection wavelength.

18. The device according to claim 4, further comprising:
a supporting portion for supporting the filter, wherein
the filter is arranged above the detecting element, and fixed to the supporting portion through an adhesive.

19. The device according to claim 18, wherein:
the adhesive is made of an inorganic material.

20. The device according to claim 11, wherein:
the housing has a window portion, through which gas in the housing communicates with gas outside of the housing.
